(19) United States
(12) Patent Application Publication
(10) Pub. No.: US 2026/0347102 A1
(43) Pub. Date: Nov. 5, 2026

(54) STORAGE AND RETRIEVAL SYSTEM AND METHOD

(71) Applicant: Ocado Innovation Limited, Hatfield (GB)

(72) Inventors: Paul WESTWOOD, Hatfield (GB); Christopher GRAY, Hatfield (GB); Nicola ZIPPO, Hatfield (GB)

(21) Appl. No.: 19/705,926

(22) Filed: Jun. 12, 2026

Related U.S. Application Data
(63) Continuation of application No. PCT/EP2024/087951, filed on Dec. 20, 2024.

(30) Foreign Application Priority Data
Dec. 20, 2023 (GB) 2319577.9

(51) Int. Cl. B65G 1/04

(52) U.S. Cl. CPC B65G 1/0464

(57) ABSTRACT

A storage and retrieval system comprising includes a grid; a plurality of containers located in stacks beneath the grid; and a container lift disposed beneath the grid, the container lift comprising a lifting platform and a lift mechanism arranged to move the lifting platform vertically, the lifting platform comprising a plurality of lifting positions that are each arranged to receive a container; a lower lift interface assembly arranged to provide containers to and receive containers from the lifting platform; an upper lift interface assembly arranged to provide containers to and receive containers from the lifting platform; and a plurality of load handling devices arranged to move along the grid and configured to move the containers between the stacks and the upper lift interface assembly; wherein the upper lift interface assembly is arranged to receive containers from a first side of the lifting platform and to provide containers to a second side of the lifting platform.

### RELATED APPLICATIONS

This application is a continuation application of International Patent Application No. PCT/EP2024/087951 filed 20 Dec. 2024 and entitled “Storage and Retrieval System and Method,” which claims priority to UK Patent Application No. GB2319577.9 filed 20 Dec. 2023 and entitled “Storage and Retrieval System and Method”; the entire contents of both of which applications are incorporated herein by reference.

### FIELD OF THE INVENTION

The disclosure herein relates to automated storage and retrieval systems. More specifically but not exclusively, it relates to a storage and retrieval system using stackable containers stored in a workspace located beneath a grid, where the containers, holding objects, are transported using load handling devices travelling on top of the grid. Furthermore, it relates to a range of variations to the system that enables the efficient exchange of containers between the stacks and any peripherals or external systems.

### BACKGROUND

Some commercial and industrial activities require systems that enable the storage and retrieval of a large number of different products. One known type of system for the storage and retrieval of items in multiple product lines involves arranging storage bins or containers in stacks on top of one another, the stacks being arranged in rows. The storage bins or containers are accessed from above, removing the need for aisles between the rows and allowing more containers to be stored in a given space.

GB2520104A and its counterpart U.S. Pat. No. 10,000,377, the entire content of which is incorporated herein by reference, describes a system in which stacks of containers are arranged within a frame structure. The containers are accessed by robotic load handling devices operative on tracks located on the top of the frame structure. A system of this type is illustrated schematically in FIGS. 1 to 4 of the accompanying drawings.

The process of adding an item to storage containers is referred to as a decant operation, as inbound items are removed from any shipping containers and/or packaging and decanted into some separate storage means. Storage and retrieval system therefore typically include one or more decant stations at which decant operations are performed, wherein the decant station is arranged to receive storage containers and to enable items to be added to the contents of the storage containers. Then, to fulfil a customer order, one or more storage containers containing outbound items are delivered to a picking station, at which the ordered products are picked out of the containers, e.g. by a manual picker or by a robotic picking device.

In storage and retrieval systems such as those described above, storage containers are typically moved between the stacks and any peripheral devices/inventory handling stations, such as decant stations, picking stations or combined pick and decant station of the systems, by the robotic load handling devices. However, some systems also include conveyor interfaces that transport containers between the frame structure and the peripherals. For example, GB2546601A describes such a storage and retrieval system in which the robotic load handling devices can deposit containers on to conveyor belts that then transfer the containers from the frame structure to a vehicle loading area.

The present invention aims to overcome the problems associated with storage and retrieval systems that include conveyor interfaces between the frame structure and any other part of the system, such as any peripherals, or any external system. In particular, these conveyor interfaces typically have limited throughput, which limits the overall efficiency of the system.

It is against this background that the present invention has been devised.

### SUMMARY OF THE INVENTION

The arrangements described herein provide a scalable and cost effective means for increasing the throughput, and therefore the overall efficiency, of storage and retrieval systems that include conveyor interfaces.

According to a first aspect, there is provided a storage and retrieval system. The storage and retrieval system comprises a grid, a plurality of containers located in stacks beneath the grid, and a container lift disposed beneath the grid. The container lift comprises a lifting platform and a lift mechanism arranged to move the lifting platform vertically, the lifting platform comprising a plurality of lifting positions that are each arranged to receive a container. The system further comprises a lower lift interface assembly arranged to provide containers to and receive containers from the lifting platform, an upper lift interface assembly arranged to provide containers to and receive containers from the lifting platform, and a plurality of load handling devices arranged to move along the grid and configured to move the containers between the stacks and the upper lift interface assembly. The upper lift interface assembly is arranged to receive containers from a first side of the lifting platform and to provide containers to a second side of the lifting platform. Preferably, the system is arranged to move containers laterally between the lifting platform and the upper lift interface assembly. Preferably, the storage and retrieval system comprises a first transfer section arranged to transfer containers to a first side of the lifting platform and a second transfer section arranged to transfer containers to a second side of the lifting platform, the second side being opposite the first side.

Such a system provides an interface through which containers can move into and out of the grid with an increased throughput relative to prior art systems. In particular, the provision of a container lift that can simultaneously lift multiple containers towards the surface of the grid and simultaneously transfer multiple ingoing and outgoing containers into and out of the container lift enables an increased throughput. Moreover, by providing that multiple outgoing and ingoing containers can be loaded and unloaded from opposing sides of the container lift, the system provides that these outgoing and ingoing containers can be individually manipulated by the load handling devices, thereby minimising congestion on the grid.

Furthermore, the system provides elevated transfer positions at which containers are transferred between the interface and the load handling devices, minimising the time spent by the load handling devices lowering and lifting of containers from the interface. The elevated transfer positions also provide that the lifting platform can continue to lower away from the grid without the need to wait for containers to be loaded and unloaded directly from the lifting platform by the load handling devices, further optimising the throughput of the interface.

The stacks may be located beneath a storage interface portion of the grid and the container lift may then be at least partially disposed beneath a lift interface portion of the grid. The storage interface portion may be continuous with the lift interface portion of the grid. The upper lift interface assembly is preferably disposed beneath the grid. The upper lift interface assembly is preferably disposed vertically proximal to the grid, such that the upper lift interface assembly is vertically closer to the grid than the lower lift interface assembly. The vertical separation between the upper lift interface assembly is preferably sufficient to allow a container supported on the upper lift assembly to be below the grid, such that it does not obstruct load handling devices operating on grid. Preferably, at least some of the containers are supported on the upper lift assembly with minimal additional separation. For example, at least some are disposed at the same height as the uppermost container of a stack of containers (e.g. within the storage interface portion). Preferably, all of the containers supported on the upper lift interface assembly are no lower than the penultimate (i.e. secondmost) upper container of a stack of containers.

The grid may define grid spaces, and the upper lift interface assembly may then be arranged beneath a plurality of the grid spaces such that the upper lift interface assembly provides a plurality of transfer positions at which containers are transferred between the upper lift interface assembly and the load handling devices. A container supported on the upper lift interface assembly at one of the transfer positions may therefore be aligned with a grid space.

Preferably, the lift mechanism is arranged to move the lifting platform vertically between the lower lift interface assembly and upper lift interface assembly. The lift mechanism may be arranged to move the lifting platform vertically between a lower position and an upper position, the lower position being vertically separated from the upper position. The system may then be arranged such that, when in the lower position, the lifting platform is aligned with the lower lift interface assembly and, when in the upper position, the lifting platform is aligned with the upper lift interface assembly.

The lower lift interface assembly may be arranged to convey containers towards and away from the grid. The lower lift interface assembly may be arranged to convey containers received from the lifting platform away from the grid and to convey containers received from outside the grid to the lifting platform. The upper lift interface assembly may be arranged to make containers received from the lifting platform available to the load handling devices and to make containers received from the load handling devices available to the lifting platform.

The upper lift interface assembly may comprise a first transfer section and a second transfer section, the first transfer section and the second transfer section being on opposite sides of the lifting platform. The first transfer section of the upper lift interface assembly may be arranged to receive containers from the first side of the lifting platform and the second transfer section of the upper lift interface assembly arranged to provide containers to the second side of the lifting platform. Preferably, the first transfer section of the upper lift interface assembly is disposed on the first side of the lifting platform and the second transfer section of the upper lift interface assembly is disposed on the second side of the lifting platform.

The first transfer section of the upper lift interface assembly may define inward transfer positions at which containers are transferred from the upper lift interface assembly to the load handling devices and the second transfer section of the upper lift interface assembly define outward transfer positions at which containers are transferred from the load handling devices to the upper lift interface assembly. These transfer positions provide that multiple ingoing and outgoing containers can be independently and even simultaneously transferred between the interface and the load handling devices.

The storage and retrieval system may be arranged to move the containers longitudinally between the lifting platform and the lower lift interface assembly. The grid interface assembly may then be arranged such that the lower lift interface assembly is inline (i.e. in series) with the lifting platform when in the lower position. Alternatively, the storage and retrieval system may be arranged to move the containers laterally between the lifting platform and the lower lift interface assembly. The grid interface assembly may then be arranged such that the lower lift interface assembly is parallel with the lifting platform when in the lower position.

The lower lift interface assembly may be arranged to provide containers to and receive containers from one of the first side of the lifting platform and the second side of the lifting platform. Alternatively, the lower lift interface assembly may be arranged to provide containers to the first side of the lifting platform and to receive containers from the second side of the lifting platform.

The lifting platform may comprise a first platform section and a second platform section, with the first platform section and the second platform section each being configured to receive multiple containers. The lower lift interface assembly may then be arranged to provide containers to the first platform section of the lifting platform and receive containers from the second platform section of the lifting platform, and the upper lift interface assembly arranged to receive containers from the first platform section of the lifting platform and provide containers to the second platform section of the lifting platform. The first transfer section of the upper lift interface assembly may be arranged to receive containers from the first platform section and the second transfer section arranged to provide containers to second platform section.

The first platform section and the second platform section of the lifting platform may each be arranged to transport a linear arrangement of multiple containers. The lifting platform may be elongate.

The lifting platform may comprise a set of first lifting positions and a set of second lifting positions, the lower lift interface assembly being arranged to provide containers to the first lifting positions and receive containers from the second lifting positions, and the upper lift interface assembly being arranged to receive containers from the first lifting positions and provide containers to the second lifting positions. The first platform section may then provide the first lifting positions and the second platform section provide the second lifting positions

The lifting platform may comprise a single platform section, the single platform section being configured to receive multiple containers. The lower lift interface assembly may then be arranged to provide containers to and receive containers from the single platform section of the lifting platform, and the upper lift interface assembly arranged to receive containers from and provide containers to the single platform section of the lifting platform. The first transfer section of the upper lift interface assembly may be arranged to receive containers from the single platform section and the second transfer section arranged to provide containers to single platform section

The single platform section may be arranged to transport a linear arrangement of multiple containers. The lifting platform may be elongate.

The lifting platform may comprise a single set of lifting positions, the lower lift interface assembly being arranged to receive containers from and provide containers to the lifting positions, and the upper lift interface assembly being arranged to provide containers to and receive containers from the lifting positions. The single platform section may then provide the lifting positions.

The lower lift interface assembly may comprise a first interface section and a second interface section, the first interface section being arranged to provide containers to the lifting platform and the second interface section being arranged to receive containers from the lifting platform. The first interface section may be laterally adjacent to the first platform section when the lifting platform is in the lower position and the second interface section laterally adjacent to the second platform section when the lifting platform is in the lower position. Alternatively, the first interface section may be inline (i.e. in series) with the first platform section when the lifting platform is in the lower position and the second interface section inline with the second platform section when the lifting platform is in the lower position.

The lower lift interface assembly may comprise a single interface section, the single interface section being arranged to provide containers to and receive containers from the lifting platform. The single interface section may be inline (i.e. in series) with the single platform section when the lifting platform is in the lower position. Alternatively, the single interface section is parallel with the single platform section of the lifting platform when in a lower position.

The lifting platform may comprises a single level. The single level of the lifting platform may then provide both the first platform section and the second platform section of the lifting, such that they are adjoined. The first lifting positions and the second lifting positions may then be provided on the single level of the lifting platform. The first lifting positions may then be laterally adjacent to the second lifting positions. Alternatively, the single level of the lifting platform may provide the single platform section of the lifting platform. The first transfer section of the upper lift interface assembly may then be vertically aligned with the second transfer section of the upper lift interface assembly.

The lower lift interface assembly may comprise a first interface section and a second interface section, the first interface section being arranged to provide containers to the lifting platform and the second interface section being arranged to receive containers from the lifting platform. The first interface section may be laterally adjacent to the first platform section when the lifting platform is in the lower position and the second interface section laterally adjacent to the second platform section when the lifting platform is in the lower position. The first interface section may then be horizontally separated from the second interface section. The first interface section may then be vertically aligned with the second interface section. The first interface section may be parallel with the second interface section. Preferably, the first interface section and the second interface section are then on opposite lateral sides of the lifting platform. Alternatively, the first interface section may be inline (i.e. in series) with the first lifting positions when the lifting platform is in the lower position and the second interface section inline with the second lifting positions when the lifting platform is in the lower position. The first interface section may then be vertically separated from the second interface section. The first interface section may then be horizontally aligned with the second interface section. Preferably, the first interface section and the second interface section are on the same side of the lifting platform.

The lifting platform may comprises a first level and a second level, the first level being vertically separated from the second level. One of the first level and the second level may then be above the other of the first level and the second level. Preferably, one of the first level and the second level is directly above the other of the first level and the second level. The first transfer section of the upper lift interface assembly may be vertically aligned with the first level of the lifting platform when in the upper position and the second transfer section of the upper lift interface assembly vertically aligned with the second level of the lifting platform when in the upper position. The first platform section of the lifting platform y bema provided by the first level and the second platform section of the lifting platform provided by the second level. The first transfer section of the upper lift interface assembly may be vertically separated from the second transfer section of the upper lift interface assembly.

The storage and retrieval system may further comprise a conveyor system arranged to convey containers into and out from beneath the grid via the lifting platform. The conveyor system may be arranged to convey ingoing containers sequentially through the lower lift interface assembly, the lifting platform and then the upper lift interface assembly, and to convey outgoing containers sequentially through the upper lift interface assembly, the lifting platform and then the lower lift interface assembly.

The conveyor system may comprise an inward conveyor system arranged to convey containers into the grid and an outward conveyor system arranged to convey containers out from the grid. The inward conveyor system may be arranged to convey ingoing containers sequentially through the lower lift interface assembly, the lifting platform and then the upper lift interface assembly, and the outward conveyor system is arranged to convey outgoing containers sequentially through the upper lift interface assembly, the lifting platform and then the lower lift interface assembly.

The inbound conveyor system may comprise an inward lower conveyor unit provided by the lower lift interface assembly, an inward lift conveyor unit provided by the lifting platform, and an inward upper conveyor unit provided by the upper lift interface assembly. The inward lower conveyor unit may be arranged to convey containers towards the lifting platform. The inward upper conveyor unit may be arranged to convey containers away from the lifting platform. The inward lift conveyor unit may be arranged to convey containers both on to and off from the lifting platform. The inward lift conveyor unit may be arranged to convey containers both longitudinally and laterally relative to the lifting platform

The outbound conveyor system may comprise an outward lower conveyor unit provided by the lower lift interface assembly, an outward lift conveyor unit provided by the lifting platform, and an outward upper conveyor unit provided by the upper lift interface assembly. The outward lower conveyor unit may be arranged to convey containers away from the lifting platform. The outward upper conveyor unit may be arranged to convey containers on to the lifting platform. The outward lift conveyor unit may be arranged to both convey containers on to and off from the lifting platform. The outward lift conveyor unit may be arranged to convey containers both longitudinally and laterally relative to the lifting platform

The conveyor system may comprise a bidirectional lift conveyor unit provided by the lifting platform that is arranged to convey containers longitudinally between the lifting platform and the lower lift interface assembly, and to convey containers laterally between the lifting platform and the upper lift interface assembly.

Each conveyor unit may comprise more than one conveyor mechanism. Each conveyor unit may comprise any of one or more longitudinal conveyor mechanisms and one or more lateral transfer mechanisms. Each conveyor mechanism may comprise one or more of a belt conveyor device, a roller conveyor device, a chain conveyor device, a slat conveyor device, and an accumulator conveyor device. Each transfer mechanism may then comprise any of pop-up rollers, belts, chains, wheels, or forks. Alternatively, each conveyor unit could comprise an omni wheel conveyor, in which powered omni wheels having different orientations are arranged in an array such that containers can be conveyed in multiple directions.

According to a second aspect, there is provided a method of operating a storage and retrieval system comprising a grid, a plurality of containers located in stacks beneath the grid, a container lift disposed beneath the grid, the container lift comprising a lifting platform and a lift mechanism arranged to move the lifting platform vertically, the lifting platform comprising a plurality of lifting positions that are each arranged to receive a container, and a plurality of load handling devices arranged to move along the grid and configured to move the containers. The method comprises using a lower lift interface assembly to provide containers to and receive containers from the lifting platform, moving the lifting platform from the lower lift interface assembly to an upper lift interface assembly, using the upper lift interface assembly to receive containers from a first side of the lifting platform and to provide containers to a second side of the lifting platform, and using the load handling devices to transfer containers between the stacks and the upper lift interface assembly.

In each of the above aspects, the storage and retrieval system may further comprise rails or tracks arranged to form the grid and on which the load handling devices are arranged to move. The storage and retrieval system may comprise two substantially perpendicular sets of tracks or rails arranged to form the grid. The storage and retrieval system may comprise a first set of substantially parallel rails or tracks and a second set of substantially parallel rails or tracks extending substantially perpendicularly to the first set in a substantially horizontal plane. The storage and retrieval system may comprise a set of uprights, the uprights supporting the tracks, the uprights and tracks together defining a framework.

In each of the above aspects, the load handling devices may comprise a body mounted on wheels, a first set of wheels being arranged to engage with at least two tracks of the first set of tracks, the second set of wheels being arranged to engage with at least two tracks of the second set of tracks, the first set of wheels being independently moveable and driveable with respect to the second set of wheels such that when in motion only one set of wheels is engaged with the grid at any one time thereby enabling movement of the load handling device along the tracks to any point on the grid by driving only the set of wheels engaged with the tracks, the load handling devices further comprising means for removing or replacing containers from the stacks.

Other variations and advantages will become apparent from the following description.

### BRIEF DESCRIPTION OF THE DRAWINGS

These and other aspects of the invention will now be described, by way of example only, and with reference to the accompanying drawings, in which:

FIG. 1 is a schematic perspective view of a frame structure for housing a plurality of stacks of bins in a known storage system;

FIG. 2 is a schematic plan view of part of the frame structure of FIG. 1;

FIG. 3a is a schematic perspective view of one form of load handling device for use with the frame structure of FIGS. 1 and 2;

FIG. 3b is a schematic perspective cut away view of the load handling device of FIG. 3a showing a container-receiving recess of the load handling device;

FIG. 3c is a schematic perspective cut away view of the load handling device of FIG. 3a showing a container accommodated within the container-receiving recess of the load handling device;

FIG. 4 is a schematic perspective view of a known storage system comprising a plurality of load handler devices of the type shown in FIG. 3(a), 3(b) and 3(c), installed on the frame structure of FIGS. 1 and 2;

FIG. 5a is a schematic perspective view of a portion of a storage system that comprises a grid interface assembly;

FIG. 5b is a schematic top-down view of the portion of the storage system of FIG. 5a;

FIGS. 6a to 6d illustrate the arrangement shown in FIGS. 5a and 5b in various different stages of operation;

FIG. 7a is a schematic perspective view of a storage system that comprises an alternative grid interface assembly;

FIG. 7b is a schematic top-down view of the portion of the storage system of FIG. 7a;

FIG. 8 is a schematic perspective view of a storage system that comprises a further alternative grid interface assembly; and

FIG. 9 is a schematic perspective view of a storage system that comprises a yet further alternative grid interface assembly.

In the figures, like features are denoted by like reference signs where appropriate.

### DETAILED DESCRIPTION

The following embodiments represent preferred examples of how the invention may be practiced, but they are not necessarily the only examples of how this could be achieved. These examples are described in sufficient detail to enable those skilled in the art to practice the invention. Other examples may be utilised and structural changes may be made without departing from the scope of the invention as defined in the appended claims. Moreover, direction references and any other terms having an implied orientation are given by way of example to aid the reader's understanding of the particular examples described herein. They should not be read to be requirements or limitations, particularly as to the position, orientation, or use of the invention unless specifically set forth in the appended claims. Similarly, connection references (e.g., attached, coupled, connected, joined, secured, and the like) are to be construed broadly and may include intermediate members between a connection of elements and relative movement between elements. As such, connection references do not necessarily infer that two elements are directly connected and in fixed relation to each other, unless specifically set forth in the appended claims. Similarly, wording such as “movement in the n-direction” and any comparable wording, where n is one of x, y or z, is intended to mean movement substantially along or parallel to the n-axis, in either direction (i.e., towards the positive end of the n-axis or towards the negative end of the n-axis).

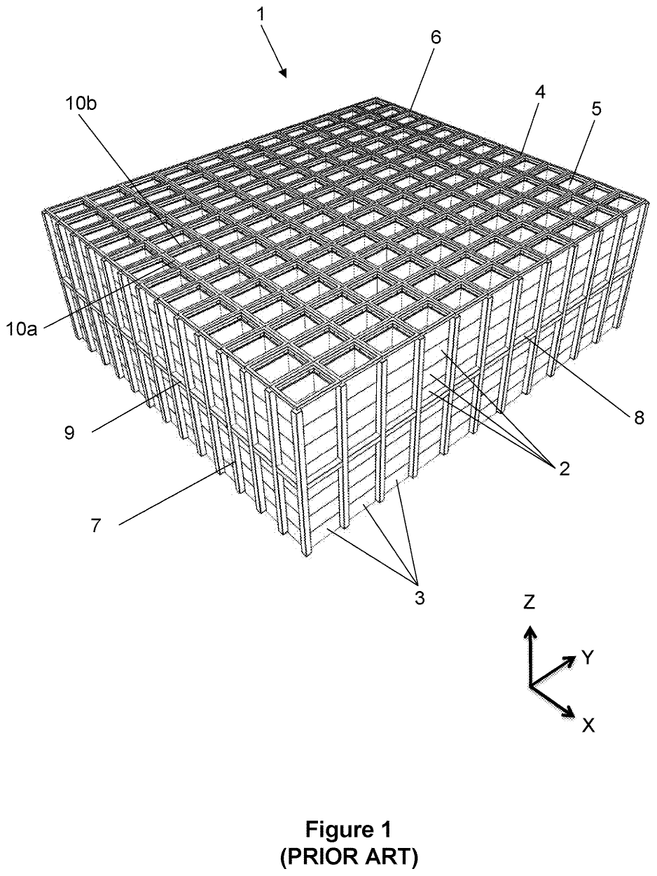

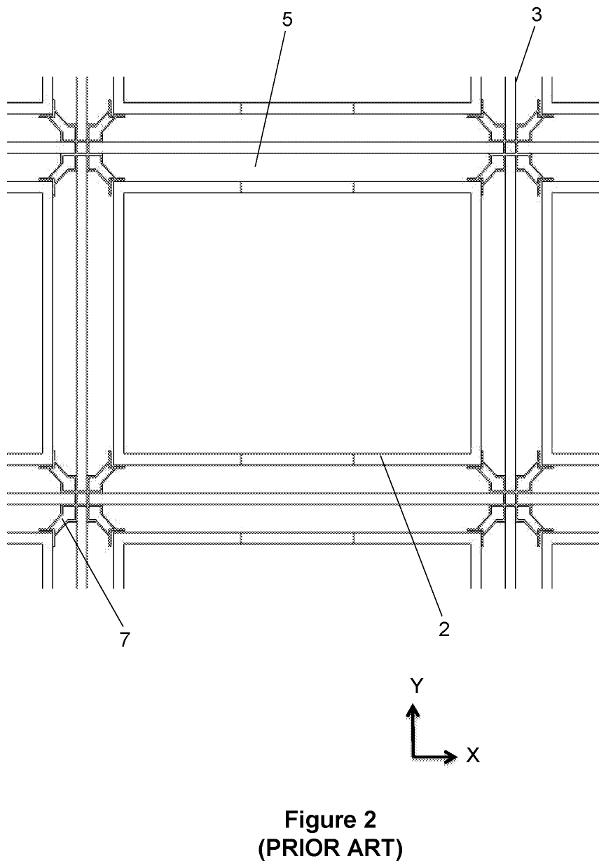

FIG. 1 is a schematic perspective view of a known storage and retrieval system 1 comprising a plurality of stacks 3 of storage containers 2 stored in a workspace located beneath a grid 4, and FIG. 2 is a top-down view showing a single stack 3 of storage containers 2 within the grid 4. As shown in FIG. 1, the stackable storage containers 2, known as bins, are stacked on top of one another to form the stacks 3. The grid 4 defines grid spaces 5 and each stack 3 of containers 2 is disposed beneath and aligned with a grid space 5 such that the containers 2 in a stack 3 can be accessed through a grid space 5. Each storage container 2 typically holds a plurality of product items (not shown), and the product items within a storage container 2 may be identical, or may be of different product types depending on the application.

The grid 4 is part of a frame structure 6 that comprises a plurality of upright members 7 that support horizontal members 8, 9. A first set of parallel horizontal members 8 is arranged perpendicularly to a second set of parallel horizontal members 9 to form a plurality of horizontal grid structures supported by the upright members 7. The members 7, 8, 9 are typically manufactured from metal. The containers 2 are stacked between the members 7, 8, 9 of the frame structure 6, so that the frame structure 6 guards against horizontal movement of the stacks 3 of containers 2, and guides vertical movement of the containers 2.

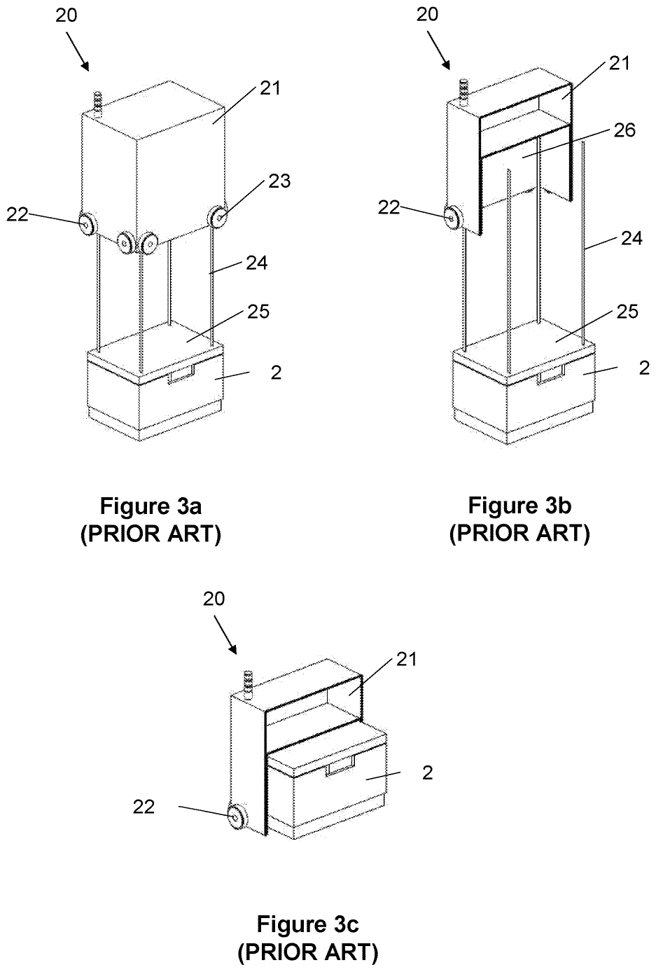

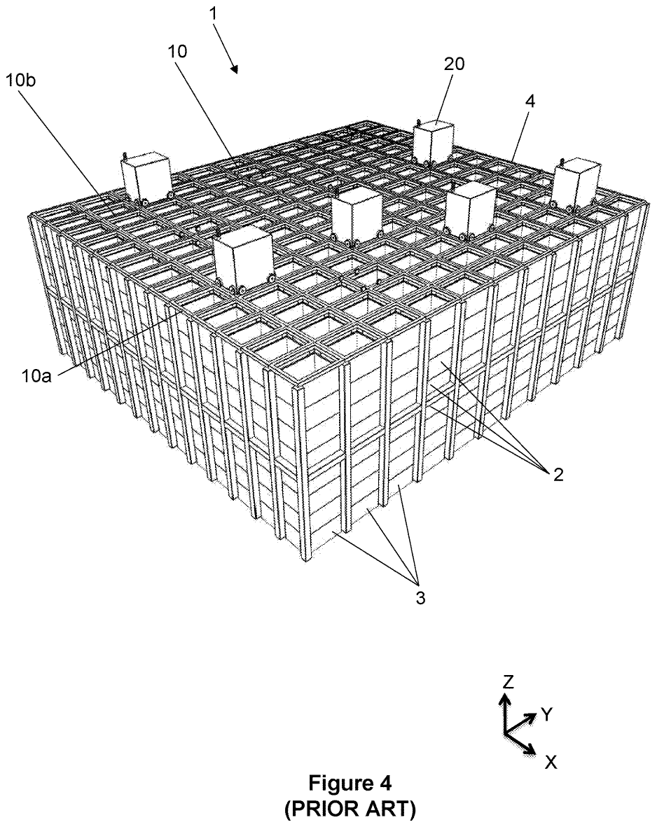

The top level of the frame structure 6 then comprises the grid 4. The grid 4 comprises rails or tracks 10a, 10b supported on the upright members 7 and arranged in a grid pattern above the stacks 3. Referring additionally to FIGS. 3a, 3b, 3c and 4, the tracks 10a, 10b support a plurality of load handling devices 20. A first set of parallel tracks 10a guide movement of the load handling devices 20 in a first direction (X) across the top of the grid 4, and a second set of parallel tracks 10b, arranged perpendicular to the first set 10a, guide movement of the load handling devices 20 in a second direction (Y), perpendicular to the first direction. In this way, the tracks 10a, 10b allow movement of the load handling devices 20 in two dimensions in the X-Y plane, so that a load handling device 20 can be moved into position above any of the stacks 102.

As shown in FIGS. 3a, 3b and 3c, each load handling device 20 comprises a vehicle 21 which is arranged to travel in the X and Y directions on the tracks 10a, 10b of the grid 4, above the stacks 3. A first set of wheels 22, consisting of a pair of wheels 22 on the front of the vehicle 21 and a pair of wheels 22 on the back of the vehicle 21, are arranged to engage with two adjacent tracks of the first set of tracks 10a. Similarly, a second set of wheels 23, consisting of a pair of wheels 23 on each side of the vehicle 21, are arranged to engage with two adjacent tracks of the second set of tracks 10b. Each set of wheels 22, 23 can be lifted and lowered, so that either the first set of wheels 22 or the second set of wheels 23 is engaged with the respective set of tracks 10a, 10b at any one time.

When the first set of wheels 22 is engaged with the first set of tracks 10a and the second set of wheels 23 are lifted clear from the second set of tracks 10b, the first set of wheels 22 can be driven, by way of a drive mechanism (not shown) housed in the vehicle 21, to move the load handling device 20 in the X direction. To move the load handling device 20 in the Y direction, the first set of wheels 22 are lifted clear of the first set of tracks 10a, and the second set of wheels 23 are lowered into engagement with the second set of tracks 10b. The drive mechanism can then be used to drive the second set of wheels 23 to achieve movement in the Y direction. In this way, one or more load handling devices 20 can move around on the grid 4 above the stacks 3 under the control of a central control system (not shown).

FIG. 4 shows a storage system 1 as described above with reference to FIGS. 1 and 2, the system 1 having a plurality of load handling devices 20 active on the grid 4 above the stacks 3. Each load handling device 20 comprises a container-lifting device 24, 25 configured to raise and lower containers 2. In the example illustrated in FIGS. 3a, 3b and 3c, the container-lifting device 24, 25 comprises winch cables or tethers 24 that are arranged to extend in a vertical direction, whose upper ends are attached to the vehicle 21 and whose lower ends are connected to a releasable container-engaging assembly 25. The container-engaging assembly 25 comprises engaging devices (which may, for example, be provided at the corners of the assembly 25) configured to releasably engage with features of the containers 2. For instance, the containers 2 may be provided with one or more apertures in their upper sides with which the engaging devices can engage. Alternatively or additionally, the engaging devices may be configured to hook under rims or lips of the containers 2, and/or to clamp or grasp the containers 2. The cables 24 may be wound up or down to raise or lower the container-engaging assembly 25, as required. One or more motors or other means may be provided to effect or control the winding up or down of the cables 24. The cables 24 and the one or more motors may together form a raising and lowering assembly configured to raise and lower the container-engaging assembly 25.

The wheels 22, 23 are arranged around the periphery of a cavity or recess, known as a container-receiving recess 26, provided by the vehicle 21. The recess is sized to accommodate a container 2 when it is lifted by the container-lifting device 24, 25, as shown in FIG. 3c. When in the recess 26, the container 2 is lifted clear of the tracks 10a, 10b beneath, so that the vehicle 21 can move laterally to a different location. On reaching the target location, for example another stack or an access point in the storage system, the container 2 can be lowered from the container receiving recess 26 and released from the container-lifting device 24, 25. In this way, the each load handling device 20 is able to lift a storage container 2 from beneath the grid 4 of a storage system of the type shown in FIG. 4, and transport the storage container 101 to another location within the system.

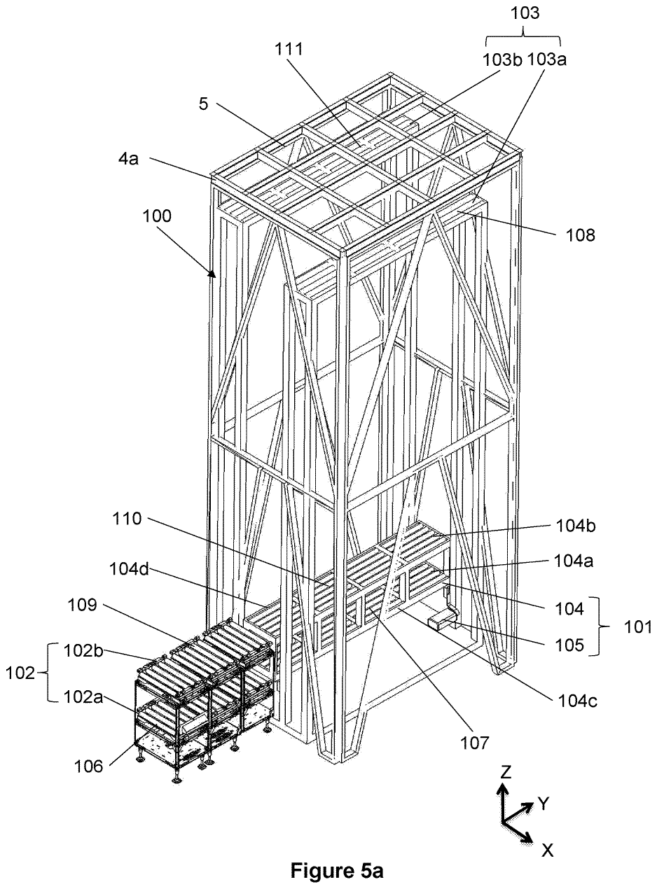

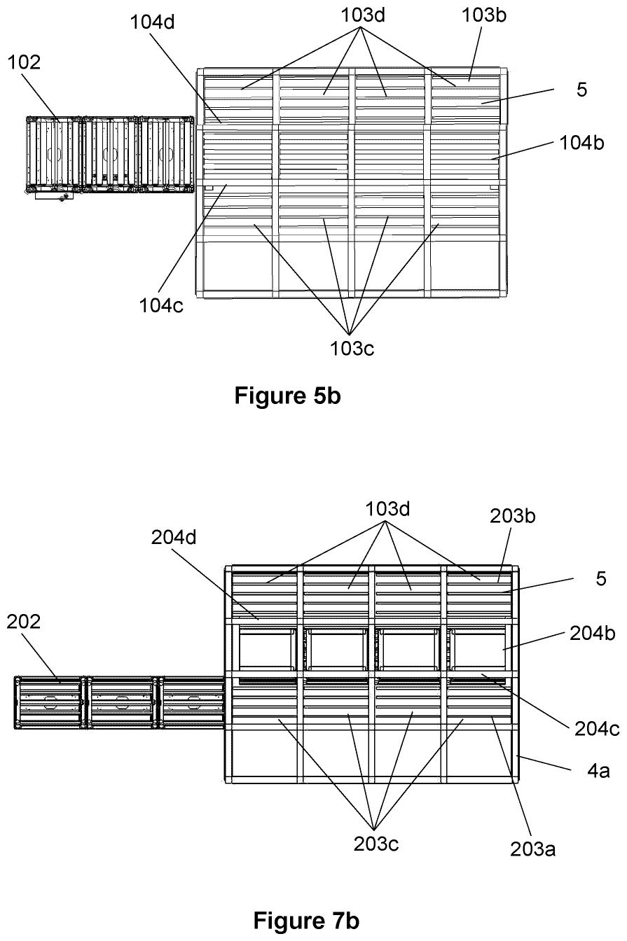

FIGS. 5a and 5b then show an arrangement suitable for use in a storage and retrieval system 1 such as that illustrated in FIGS. 1 and 4 that provides an interface for the transfer of containers 2 in to and out of the grid 4. This arrangement comprises a grid interface assembly 10 at least partially disposed beneath a lift interface portion 4a of the grid 4. The lift interface portion 4a is connected to and preferably continuous with a storage interface portion (not shown) of the grid 4, with the stacks 3 of containers 2 then being located beneath the storage interface portion.

The grid interface assembly 100 comprises a container lift 101, a lower lift interface assembly 102 and an upper lift interface assembly 103, with the upper lift interface assembly 103 being vertically separate from the lower lift interface assembly 102. The container lift 101 comprises a lifting platform 104 and a lift mechanism 105 arranged to move the lifting platform 104 vertically between the lower lift interface assembly 102 and upper lift interface assembly 103. In the arrangement shown in FIGS. 5a and 5b, the container lift 101 is a reciprocating lift that travels bi-directionally along a lift frame that is arranged to be at least partially vertical such that the lifting platform 104 moves vertically (i.e. in the Z-direction).

The lower lift interface assembly 102 is arranged to provide an interface between the grid interface assembly 100 and a sub-system or system that is external to the workspace (i.e. that is not beneath the grid 4). For example, the lower lift interface assembly 102 may be arranged to provide an interface to one or more peripherals, such as pick stations, decant stations, etc. or any other parts of the system, such as loading areas or separate grids that form part of the system 1. To do so, the lower lift interface assembly 102 may be connected to external conveyors that convey containers towards and away from the grid 4. The upper lift interface assembly 103 is then arranged to allow for the transfer of containers 2 between the grid 4 and the grid interface assembly 100. To do so, the upper lift interface assembly 103 provides a plurality of transfer positions at which containers 2 are transferred between the upper lift interface assembly 103 and the load handling devices 20 operating on the grid 4.

The lifting platform 104 comprises a plurality of lifting positions that are each arranged to receive and transport a container 2. In the arrangement shown in FIGS. 5a and 5b, the lifting platform 104 comprises a first platform section 104a and a second platform section 104b, with the first platform section 104a and the second platform section 104b each being configured to receive multiple containers 2. The lower lift interface assembly 102 is arranged to provide containers 2 to the first platform section 104a of the lifting platform 104 and receive containers from the second platform section 104b of the lifting platform 104. The upper lift interface assembly 103 is then arranged to receive containers 2 from the first platform section 104a of the lifting platform 104 and provide containers 2 to the second platform section 104b of the lifting platform 104.

In the arrangement shown in FIGS. 5a and 5b, the lifting platform 104 is elongate. In particular, the lifting platform 104 is arranged such that each of the first platform section 104a and second platform section 104b can receive and transport multiple containers 2 in a single linear arrangement extending longitudinally along the lifting platform 104. The first platform section 104a of the lifting platform 104 is then vertically separated from the second platform section 104b of the lifting platform 104 such that the lifting platform 104 has two separate levels. In the arrangement shown in FIGS. 5a and 5b, the first platform section 104a of the lifting platform 104 is below the second platform section 104b of the lifting platform 104. In particular, the first platform section 104a of the lifting platform 104 is directly below the second platform section 104b of the lifting platform 104 (i.e. such that the first platform section 104a and the second platform section 104b are horizontally aligned).

As described above, the lift mechanism 105 is arrange to move the lifting platform 104 vertically between the lower lift interface assembly 102 and upper lift interface assembly 103. To do so, the lift mechanism 105 is arranged to move the lifting platform 104 vertically between a lower position and an upper position, the lower position being vertically separated from the upper position. The grid interface assembly 100 is then arranged such that, when in the lower position, the lifting platform 104 is aligned with the lower lift interface assembly 102 and, when in the upper position, the lifting platform 104 is aligned with the upper lift interface assembly 103.

The lower lift interface assembly 102 comprises both a first interface section 102a and a second interface section 102b, the first interface section 102a being arranged to provide containers 2 to the first platform section 104a of the lifting platform 104 and the second interface section 102b being arranged to receive containers 2 from the second platform section 104b of the lifting platform 104.

In order to both provide containers 2 to the first platform section 104a of the lifting platform 104 and receive containers 2 from the second platform section 104b of the lifting platform 104, the first interface section 102a is then vertically displaced relative to the second interface section 102b. In particular, the first interface section 102a is directly below the second interface section 102b. The grid interface assembly 100 is arranged such that, when in the lower position, the first interface section 102a of the lower lift interface assembly 102 is vertically aligned with the first platform section 104a of the lifting platform 104 and the second interface section 102b of the lower lift interface assembly 102 is vertically aligned with the second platform section 104b of the lifting platform 104.

Such an arrangement provides that the containers 2 can be promptly, and preferably simultaneously, loaded on to the lifting platform 104 from the lower lift interface assembly 102 and unloaded off from the lifting platform 104 on to the lower lift interface assembly 102. In particular, the loading and unloading of containers 2 can be implemented either synchronously to optimise the process, simultaneously so as to ensure rapid throughput without the need to ensure synchronicity, or successively but without the delay of repositioning the lifting platform 104.

In the arrangement shown in FIGS. 5a and 5b, the grid interface assembly 100 is arranged to move the containers 2 longitudinally between the lifting platform 104 and the lower lift interface assembly 102. Consequently, the grid interface assembly 100 is arranged such that the lower lift interface assembly 102 is inline (i.e. in series) with the lifting platform 104 when in the lower position. In other words, when in the lower position, the lower lift interface assembly 102 is longitudinally adjacent to the lifting platform 104, with the first interface section 102a of the lower lift interface assembly 102 inline with the first platform section 104a of the lifting platform 104 and the second interface section 102b of the lower lift interface assembly 102 inline with the second platform section 104b of the lifting platform 104.

The upper lift interface assembly 103 comprises a first transfer section 103a and a second transfer section 103b, the first transfer section 103a of the upper lift interface assembly 103 being arranged to receive containers 2 from the first platform section 104a of the lifting platform 104 and the second transfer section 103b of the upper lift interface assembly 103 being arranged to provide containers 2 to the second platform section 104b of the lifting platform 104.

The upper lift interface assembly 103 is arranged to receive containers 2 from a first side 104c of the lifting platform 104 and to supply containers 2 into a second side 104d of the lifting platform 104, the first side 104c being opposite to the second side 104d. In particular, the first transfer section 103a of the upper lift interface assembly 103 is arranged to receive containers from the first side 104c of the lifting platform 104 and the second transfer section 103b of the upper lift interface assembly 103 is arranged to provide containers 2 to the second side 104d of the lifting platform 104. To do so, the first transfer section 103a of the upper lift interface assembly 103 is disposed on the first side 104c of the lifting platform 104 and the second transfer section 103b of the upper lift interface assembly 103 is disposed on the second side 104d of the lifting platform 104. The first transfer section 103a of the upper lift interface assembly 103 is therefore horizontally displaced relative to the second transfer section 103b of the upper lift interface assembly 103.

The grid interface assembly 100 is then arranged such that, when the lifting platform 104 is in the upper position, the first transfer section 103a of the upper lift interface assembly 103 is aligned with the first platform section 104a of the lifting platform 104 and the second transfer section 103b of the upper lift interface assembly 103 is aligned with the second platform section 104b of the lifting platform 104. The first transfer section 103a of the upper lift interface assembly 103 is therefore vertically displaced relative to the second transfer section 103b of the upper lift interface assembly 103. Such an arrangement provides that the containers 2 can be promptly, and preferably simultaneously, loaded on to the lifting platform 104 from the upper lift interface assembly 103 and unloaded off from the lifting platform 104 on to the upper lift interface assembly 103.

The first transfer section 103a of the upper lift interface assembly 103 defines a set of inward transfer positions 103c at which containers 2 are transferred from the upper lift interface assembly 103 to the load handling devices 20 and the second transfer section 103b of the upper lift interface assembly 103 defines a set of outward transfer positions 103d at which containers 2 are transferred from the load handling devices 20 to the upper lift interface assembly 103. Each of the inward transfer positions 103c is therefore arranged to receive a container 2 from the first platform section 104a of the lifting platform 104 and each of the outward transfer positions 103d is arranged to provide a container 2 to the second platform section 104b of the lifting platform 104. The storage system 1 is then configured to use the inward transfer positions 103c to transfer containers 2 from the upper lift interface assembly 103 to the load handling devices 20 and to use the outward transfer positions 103d to transfer containers 2 from the load handling devices 20 to the upper lift interface assembly 103. In particular, a central controller (not shown) of the storage system 1 is configured to ensure that the load handling devices 20 only use the inward transfer positions 103c to collect incoming containers 2 from grid interface assembly 100 and to use the outward transfer positions 103d to deposit outgoing containers 2 at the grid interface assembly 100.

As described above, the grid 4 defines grid spaces 5 and the load handling devices 20 are configured to raise and lower containers 2 through the grid spaces 5. Each of the inward transfer positions 103c and the outward transfer positions 103d is therefore arranged beneath a grid space 5 in order to allow the load handling devices 20 operating on the grid 4 to transfer containers 2 between the load handling devices 20 and the upper lift interface assembly 103.

In order to transfer containers 2 in to and out of the grid 4, the grid interface assembly 100 comprises a conveyor system arranged to convey containers 2 into and out from the grid 4 via the lifting platform 104. In particular, the conveyor system is arranged to convey ingoing containers sequentially through the lower lift interface assembly 102, the lifting platform 104 and then the upper lift interface assembly 103, and to convey outgoing containers sequentially through the upper lift interface assembly 103, the lifting platform 104 and then the lower lift interface assembly 102.

In the arrangement shown in FIGS. 5a and 5b, the conveyor system comprises separate inward and outward conveyor systems, wherein the inward conveyor system is arranged to convey ingoing containers sequentially through the lower lift interface assembly 102, the lifting platform 104 and then the upper lift interface assembly 103, and the outward conveyor system is arranged to convey outgoing containers sequentially through the upper lift interface assembly 103, the lifting platform 104 and then the lower lift interface assembly 102. In particular, the inbound conveyor system comprises an inward lower conveyor unit 106 provided by the first interface section 102a of the lower lift interface assembly 102, an inward lift conveyor unit 107 provided by the first platform section 104a of the lifting platform 104, and an inward upper conveyor unit 108 provided by the first transfer section 103a of the upper lift interface assembly 103. The outbound conveyor system then comprises an outward lower conveyor unit 109 provided by the second interface section 102b of the lower lift interface assembly 102, an outward lift conveyor unit 110 provided by the second platform lift section 104b of the lifting platform 104, and an outward upper conveyor unit 111 provided by the second transfer section 103b of the upper lift interface assembly 103.

The inward lower conveyor unit 106 is arranged to convey containers towards the first platform section 104a of the lifting platform 104, while the outward lower conveyor unit 109 is arranged to convey containers away from the second platform section 104b of the lifting platform 104. The inward upper conveyor unit 108 is then arranged to convey containers away from the first platform section 104a of the lifting platform 104, while the outward upper conveyor unit 110 is arranged to convey containers on to the second platform section 104b of the lifting platform 104.

The inward lift conveyor unit 107 provided by the first platform section 104a of the lifting platform 104 is arranged to convey containers both on to and off from the first platform section 104a of the lifting platform 104. The outward lift conveyor unit 110 provided by the second platform section 104b of the lifting platform 104 is then also arranged to both convey containers on to and off from the second platform section 104b of the lifting platform 104. In this regard, each conveyor unit may comprise more than one conveyor mechanism. For example, each conveyor unit may comprise one or more roller conveyors for longitudinal movement of containers and one or more transfer mechanisms (e.g. pop-up) for lateral movement of containers on to and out from the first level of the lifting platform 104.

In the arrangement shown in FIGS. 5a and 5b, the inward lift conveyor unit 107 and the outward lift conveyor unit 110 are arranged to convey containers both longitudinally and laterally relative to the lifting platform 104. In particular, when in the lower position, the inward lift conveyor unit 107 is arranged to convey containers longitudinally on to the first platform section 104a of the lifting platform 104 from the first interface section 102a of the lower lift interface assembly 102. Then, when in the upper position, the inward lift conveyor unit 107 is arranged to convey containers laterally on to the first transfer section 103a of the upper lift interface assembly 103. When in the upper position, the outward lift conveyor unit 110 is arranged to convey containers laterally on to the second platform section 104b of the lifting platform 104 from the second transfer section 103b of the upper lift interface assembly 103. Then, when in the lower position, the outward lift conveyor unit 110 is arranged to convey containers longitudinally off from the second platform section 104b of the lifting platform 104 to the second interface section 102b of the lower lift interface assembly 102.

In the arrangement shown in FIGS. 5a and 5b, both the inward lower conveyor unit 106 and the outward lower conveyor unit 109 are provided by active (i.e. powered) roller conveyors that are arranged drive containers 2 longitudinally on to and away from the lifting platform 104. The inward lift conveyor unit 107 and the outward lift conveyor unit 110 of the lifting platform 104 then each comprise one or more active (i.e. powered) roller conveyors arranged to convey containers 2 longitudinally along the lifting platform 104 and thereby drive containers 2 on to and away from the lower lift interface assembly 102 respectively. The inward lift conveyor unit 107 and the outward lift conveyor unit 110 then also comprise one or more lateral transfer mechanisms arranged to convey containers laterally and thereby push containers 2 on to and pull containers 2 from the upper lift interface assembly 103. By way of example, a lateral transfer mechanism may comprise a pop-up transfer conveyor in which the transfer conveyor rises up in order to lift the article being conveyed away from another conveyor having a different orientation. In such a pop-up transfer conveyor the transfer conveyor may comprise any of rollers, belts, chains, wheels, a shuttle or fork transfer. In an alternative example, each conveyor unit could comprise an omni wheel conveyor, in which powered omni wheels having different orientations are arranged in an array such that containers 2 can be conveyed in multiple directions. The inward upper conveyor unit 108 and the outward upper conveyor unit 111 are then provided by passive (i.e. unpowered) roller conveyors that allow lateral movement of containers 2 on to and away from the upper lift interface assembly 103.

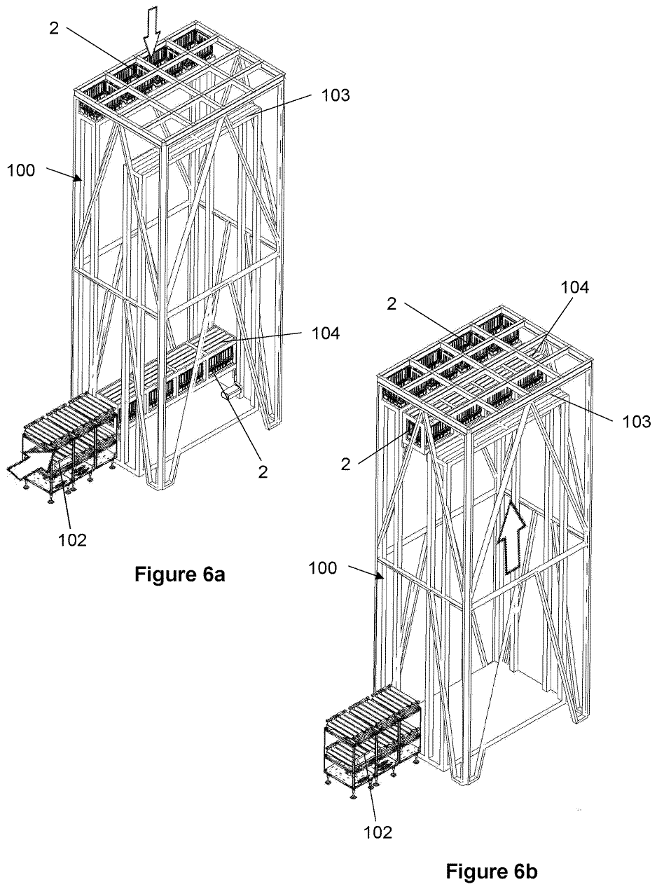

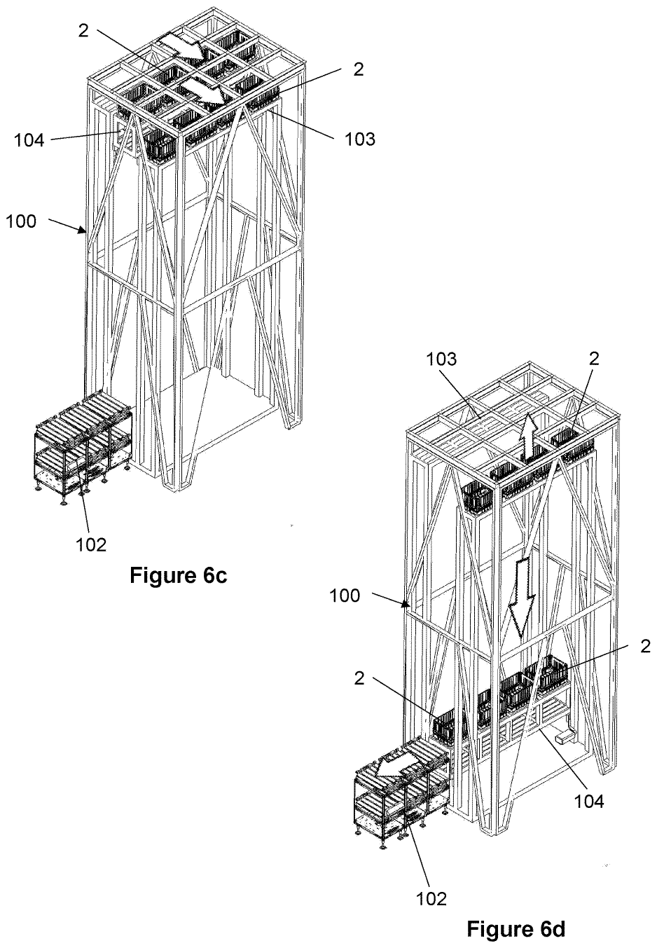

FIGS. 6a to 6d then illustrate the arrangement shown in FIGS. 5a and 5b in various different stages of operation when transferring containers 2 in to and out of the grid 4 using the grid interface assembly 100.

With the lifting platform 104 in the lower position, the system 1 loads incoming containers 2 onto the first platform section 104a of the lifting platform 104 via the first interface section 102a of the lower lift interface assembly 102. The system 1 also uses the load handling devices 20 to deposit outgoing containers 2 into the outward transfer positions 103d provided by the second transfer section 103b of the upper lift interface assembly 103. FIG. 6a therefore shows the platform 104 in the lower position with incoming containers 2 loaded on the first platform section 104a of the lifting platform 104 and with outgoing containers 2 in the outward transfer positions 103d of the second transfer section 103b of the upper lift interface assembly 103. The lift mechanism 105 then raises the lifting platform 104 from the lower position to the upper position, as shown in FIG. 6b.

With the lifting platform 104 in the upper position, the system 1 simultaneously unloads the incoming containers 2 from the first platform section 104a of the lifting platform 104 into the inward transfer positions 103c provided by the first transfer section 103a of the upper lift interface assembly 103 and loads outgoing containers 2 from the second transfer section 103b of the upper lift interface assembly 103 into the second platform section 104b of the lifting platform 104. FIG. 6c therefore shows the lifting platform 104 in the upper position with the outgoing containers 2 loaded on the second platform section 104b of the lifting platform 104 and with the incoming containers 2 in the inward transfer positions 103c provided by the first transfer section 103a of the upper lift interface assembly 103.

The lift mechanism 105 then lowers the lifting platform 104 from the upper position to the lower position, as shown in FIG. 6d. With the lifting platform 104 in the lower position, the system 1 unloads outgoing containers 2 from the second platform section 104b of the lifting platform 104 onto the second interface section 102b of the lower lift interface assembly 102. The system 1 uses the load handling devices 20 to collect the incoming containers 2 from the inward transfer positions 103c provided by the first transfer section 103a of the upper lift interface assembly 103.

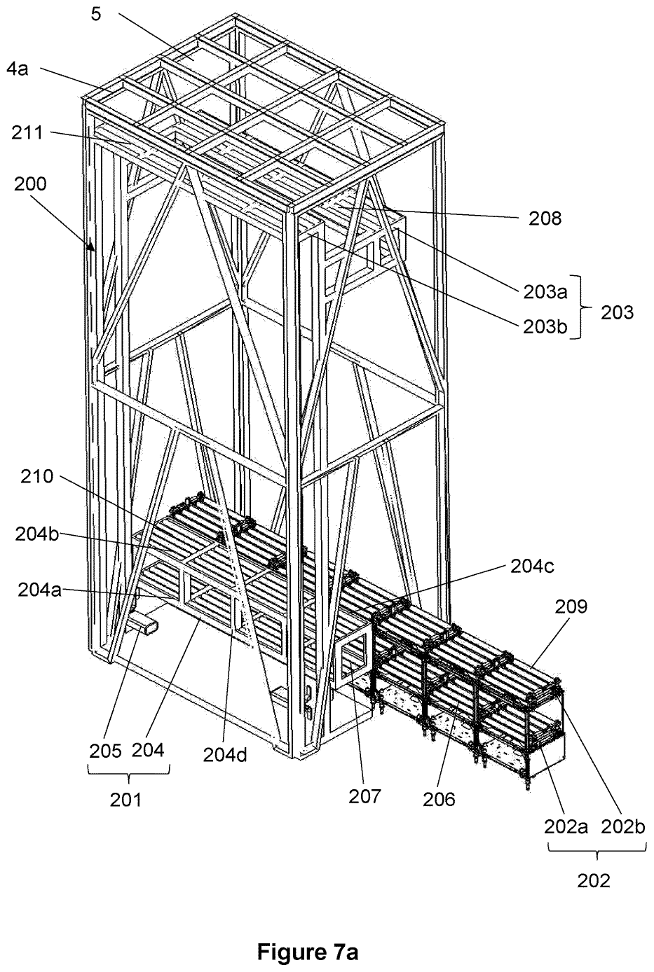

FIGS. 7a and 7b then illustrate an alternative example of a grid interface assembly 200 suitable for use with the sortation system 1 of FIG. 4. The grid interface assembly 200 of FIGS. 7a and 7b is substantially similar to that of FIGS. 5a and 5b and corresponding reference numerals have therefore been used for like or corresponding parts or features. However, in contrast with the grid interface assembly 100 of FIGS. 5a and 5b, the grid interface assembly 200 of FIGS. 7a and 7b comprises a lower lift interface assembly 204 that is arranged to move the containers 2 laterally between the lifting platform 204 and the lower lift interface assembly 202, rather than longitudinally. Consequently, the grid interface assembly 200 of FIGS. 7a and 7b is arranged such that the lower lift interface assembly 202 is parallel with the lifting platform 204 when in the lower position. In other words, when in the lower position, the lower lift interface assembly 202 is laterally adjacent to the lifting platform 204, with the first interface section 202a of the lower lift interface assembly 202 alongside the first platform section 204a of the lifting platform 204 and the second interface section 202b of the lower lift interface assembly 202 alongside the second platform section 204b of the lifting platform 204.

In the arrangement shown in FIGS. 7a and 7b, the inward lower conveyor unit 206 provided by the first interface section 202a of the lower lift interface assembly 202 and the outward lower conveyor unit 209 provided by the second interface section 202b of the lower lift interface assembly 202 are each arranged to convey containers both longitudinally and laterally relative to the lower lift interface assembly 202. In particular, the inward lower conveyor unit 206 is arranged to convey containers longitudinally along the first interface section 202a toward the lifting platform 204, and then laterally on to the first platform section 204a of the lifting platform 204. The outward lower conveyor unit 209 is then arranged to allow containers to be conveyed laterally on to the second interface section 202b from the second platform section 204b of the lifting platform 204 and then longitudinally along the second interface section 202b away from the lifting platform 204.

The grid interface assembly 200 shown in FIGS. 7a and 7b operates in essentially the same way as the grid interface assembly 100 of FIGS. 5a and 5b. However, while the grid interface assembly 200 shown in FIGS. 7a and 7b consumes more space under the grid 4 than the grid interface assembly 100 of FIGS. 5a and 5b, it does provide for quicker loading and unloading of the lifting platform 204 when at the lower lift interface assembly 202, thereby improving the throughput of the grid interface assembly 200.

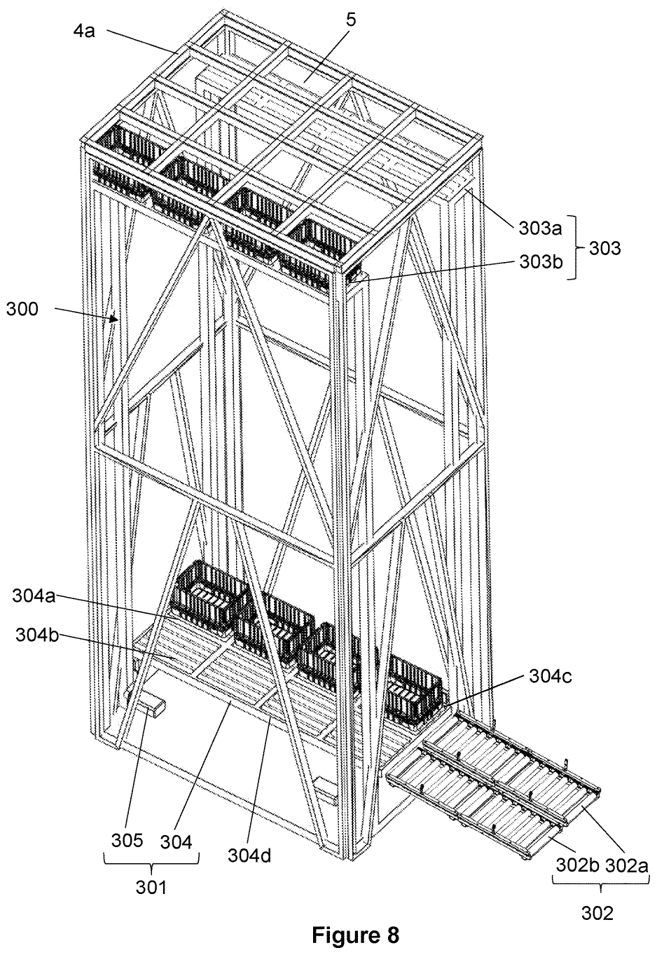

FIG. 8 then illustrates a further alternative example of a grid interface assembly 300 suitable for use with the sortation system 1 of FIG. 4. The grid interface assembly 300 of FIG. 8 is substantially similar to that of FIGS. 5a and 5b and corresponding reference numerals have therefore been used for like or corresponding parts or features. However, in contrast with the grid interface assembly 100 of FIGS. 5a and 5b, the grid interface assembly 300 of FIG. 8 comprises a lifting platform 304 having just a single level, such that the first platform section 304a and the second platform section 304b of the lifting platform 304 are adjoined.

As with the grid interface assembly 100 of FIGS. 5a and 5b, in the grid interface assembly 300 of FIG. 8 the upper lift interface assembly 303 is arranged to receive containers 2 from a first side 304c of the lifting platform 304 and to supply containers 2 into a second side 304d of the lifting platform 304, the first side 104c being opposite to the second side 104d. The first transfer section 303a of the upper lift interface assembly 303 is therefore disposed on the first side 304c of the lifting platform 304 and the second transfer section 303b of the upper lift interface assembly 303 is disposed on the second side 304d of the lifting platform 304. However, so as to be able to promptly, and preferably simultaneously, receive containers 2 from the first platform section 304a of the lifting platform 304 and provide containers 2 to the second platform section 304b of the lifting platform 304, the first transfer section 103a is vertically aligned with the second transfer section 103b. Consequently, when the lifting platform 304 is in the upper position, the first transfer section 303a of the upper lift interface assembly 303 is aligned with the first platform section 304a of the lifting platform 304 and the second transfer section 303b of the upper lift interface assembly 303 is aligned with the second platform section 304b of the lifting platform 304.

As with the grid interface assembly 100 of FIGS. 5a and 5b, in the grid interface assembly 300 of FIG. 8 the lower lift interface assembly 302 comprises both a first interface section 302a and a second interface section 302b, the first interface section 302a being arranged to provide containers 2 to the first platform section 304a of the lifting platform 304 and the second interface section 302b being arranged to receive containers 2 from the second platform section 104b of the lifting platform 304. However, so as to be able to promptly, and preferably simultaneously, provide containers 2 to the first platform section 304a of the lifting platform 304 and receive containers 2 from the second platform section 304b of the lifting platform 304, the first interface section 302a is vertically aligned with the second interface section 302b. Consequently, when the lifting platform 304 is in the lower position, the first interface section 302a of the lower lift interface assembly 302 is aligned with the first platform section 304a of the lifting platform 304 and the second interface section 302b of the lower lift interface assembly 302 is aligned with the second platform section 304b of the lifting platform 304.

In the arrangement shown in FIG. 8, the grid interface assembly 300 is arranged to convey containers longitudinally between the lifting platform 304 and the lower lift interface assembly 302. Consequently, the grid interface assembly 300 of FIG. 8 is arranged such that the lower lift interface assembly 302 is inline (i.e. in series) with the lifting platform 304 when in the lower position. In other words, when in the lower position, the lower lift interface assembly 302 is longitudinally adjacent to the lifting platform 304, with the first interface section 302a of the lower lift interface assembly 302 aligned with the first platform section 304a of the lifting platform 304 and the second interface section 302b of the lower lift interface assembly 302 aligned with the second platform section 304b of the lifting platform 304.

The grid interface assembly 300 shown in FIG. 8 operates in essentially the same way as the grid interface assembly 100 of FIGS. 5a and 5b. However, while the grid interface assembly 300 shown in FIG. 8 consumes more space under the grid 4 than the grid interface assembly 100 of FIGS. 5a and 5b, it does provide for easier maintenance of both lifting platform 304 and the lower lift interface assembly 302.

In an alternative arrangement (not shown), the grid interface assembly 300 may be arranged to convey containers laterally between the lifting platform 304 and the lower lift interface assembly 302. In such an arrangement, the grid interface assembly 300 would then be arranged such that the lower lift interface assembly 302 is parallel with the lifting platform 304 when in the lower position. So as to be able to promptly, and preferably simultaneously, provide containers 2 to the first platform section 304a of the lifting platform 304 and receive containers 2 from the second platform section 304b of the lifting platform 304, the first interface section 302a of the lower lift interface assembly 302 would then be disposed on the first side 304c of the lifting platform 304 and the second interface section 302b of the lower lift interface assembly 302 disposed on the second side 304d of the lifting platform 304. The inward lower conveyor unit 306 provided by the first interface section 302a of the lower lift interface assembly 302 and the outward lower conveyor unit 309 provided by the second interface section 302b of the lower lift interface assembly 302 would then each be arranged to convey containers both longitudinally and laterally relative to the lower lift interface assembly 302. In particular, the inward lower conveyor unit 306 would be arranged to convey containers 2 longitudinally along the first interface section 302a toward the lifting platform 304, and then laterally on to the first platform section 304a of the lifting platform 304. The outward lower conveyor unit 309 would then be arranged to allow containers to be conveyed laterally on to the second interface section 302b from the second platform section 304b of the lifting platform 304 and then longitudinally along the second interface section 302b away from the lifting platform 304.

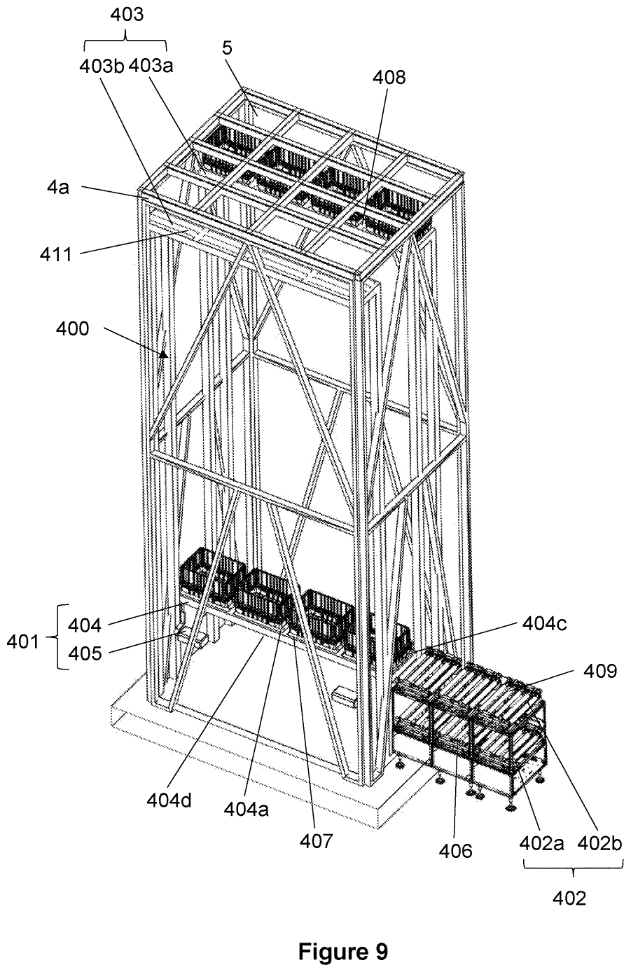

FIG. 9 then illustrates a yet further alternative example of a grid interface assembly 400 suitable for use with the sortation system 1 of FIG. 4. The grid interface assembly 400 of FIG. 9 is substantially similar to that of FIGS. 5a and 5b and corresponding reference numerals have therefore been used for like or corresponding parts or features. However, in contrast with the grid interface assembly 100 of FIGS. 5a and 5b, the grid interface assembly 400 of FIG. 9 comprises a lifting platform 404 having just a single platform section 404a that is used for both ingoing containers and outgoing containers. The first transfer section 403a and the second transfer section 403b of the upper lift interface assembly 403 are then disposed on opposite sides of the lifting platform 404 when in the upper position, and the first transfer section 403a is vertically aligned with the second transfer section 403b. Consequently, when the lifting platform 404 is in the upper position, the first transfer section 403a of the upper lift interface assembly 403 is aligned with the platform section 404a of the lifting platform 404 and the second transfer section 403b of the upper lift interface assembly 403 is also aligned with the platform section 404a of the lifting platform 404.

In the arrangement shown in FIG. 9, the lower lift interface assembly 402 has first and second interface sections 402a, 402b, with the first interface section 402a being vertically displaced relative to the second interface section 402b, such that one is above the other. The first interface section 402a is arranged to provide containers 2 to the lifting platform 404 and the second interface section 402b is arranged to receive containers 2 from the lifting platform 404. The lift mechanism 405 is then arranged to move the lifting platform 404 between an upper position, a lower position, and an intermediate position (i.e. that is between the upper position and the lower position).

When in the lower position, the lifting platform 404 is aligned with the lower of the first and second interface sections 402a, 402b of the lower interface assembly 402. Then, when in the intermediate position, the lifting platform 404 is aligned with the upper of the first and second interface sections 402a, 402b of the lower interface assembly 402. In the arrangement shown in FIG. 9, the first interface section 402a is below the second interface section 402b, such that the lifting platform 404 is aligned with the first interface section 402a when in the lower position and is aligned with the second interface section 402b when in the intermediate position. However, in an alternative arrangement, the first interface section 402a may be above the second interface section 402b, such that the lifting platform 404 is aligned with the first interface section 402a when in the intermediate position and is aligned with the second interface section 402b when in the lower position.

The conveyor system then comprises a bidirectional lift conveyor unit 407 provided by the lifting platform 404 that is arranged to convey containers 2 both longitudinally and laterally. In particular, the bidirectional lift conveyor unit 407 is arranged to convey containers longitudinally between the lifting platform 404 and the lower lift interface assembly 402, and to convey containers laterally between the lifting platform 404 and the upper lift interface assembly 403.

The storage system 1 is then configured to position the lifting platform 404 in the lower position, and into alignment with first interface section 402a, in order to receive incoming containers 2 from the lower lift interface assembly 402 before being lifted by the lift mechanism 405 to the upper position. When in the upper position, the storage system 1 is configured to use the upper lift interface assembly 403 to promptly, and preferably simultaneously, convey the incoming containers 2 off from the lifting platform 404 onto the first transfer section 403a of the upper lift interface assembly 403 and convey outgoing containers 2 onto the lifting platform 404 from the second transfer section 403b of the upper lift interface assembly 403. When outgoing containers 2 have been loaded onto the lifting platform 404, the storage system 1 is then configured to use the lift mechanism 405 to lower the lifting platform 404 to the intermediate position, and into alignment with the second interface section 402b, in order to unload outgoing containers 2 from the lifting platform 404 on to the second interface section 402b of the lower lift interface assembly 402. Once unloaded, the storage system 1 is configured to use the lift mechanism 405 to lower the lifting platform 404 to the lower position, and into alignment with first interface section 402a, in order to receive another load of incoming containers 2 from the lower lift interface assembly 402.

In the arrangement illustrated in FIG. 9, the lower lift interface assembly 402 comprises both a first interface section 402a and a second interface section 402b, with the first interface section 402a being arranged to provide ingoing containers to the lifting platform 404 and the second interface section 402b being arranged to receive outgoing containers from the lifting platform 404. In an alternative arrangement (not shown), the lower lift interface assembly 402 may comprise a single interface section that is used for both ingoing containers and outgoing containers. The conveyor system may then comprise a bidirectional lower conveyor provided by the lower lift interface assembly 402 that is arranged to convey ingoing containers 2 towards the lifting platform 404 and to convey outgoing containers 2 away from the lifting platform 404. The lower lift interface assembly 402 may then be connected to a bifurcated external conveyor that is arranged to selectively convey ingoing containers 2 along a first branch of the bifurcated external conveyor and to convey outgoing containers 2 along a second branch of the bifurcated external conveyor.

In the arrangement illustrated in FIG. 9, the grid interface assembly 400 is arranged to convey containers longitudinally between the lifting platform 404 and the lower lift interface assembly 402. Consequently, the grid interface assembly 400 of FIG. 9 is arranged such that the lower lift interface assembly 402 is inline (i.e. in series) with the lifting platform 404 when in both the lower position and the intermediate position.

In an alternative arrangement (not shown), the grid interface assembly 400 may be arranged to convey containers laterally between the lifting platform 404 and the lower lift interface assembly 402. The grid interface assembly 400 would then be arranged such that the lower lift interface assembly 402 is parallel with the lifting platform 404. In one example of such an arrangement, the lower lift interface assembly 402 may be essentially the same as that described above with reference to FIG. 7a. The grid interface assembly 400 would then be configured to position the lifting platform 404 in one of the lower position and the intermediate position when receiving ingoing containers 2 from the first interface section 402a and in the other of the lower position and the intermediate position when providing outgoing containers 2 to the second interface section 402b. In another example of such an arrangement, the lower lift interface assembly 402 may be similar to the upper lift interface assembly 403 in that the first interface section 402a and the second interface section 402b of the lower lift interface assembly 402 may be disposed on opposite sides of the lifting platform 404 and be vertically aligned, i.e. on the same level. In particular, the first interface section 402a of the lower lift interface assembly 402 may be disposed on the first side 404c of the lifting platform 404 and the second interface section 402b of the lower lift interface assembly 402 disposed on the second side 404d of the lifting platform 404. The storage system 1 may then be configured to promptly, and preferably simultaneously, convey the incoming containers 2 on to the lifting platform 404 from the first interface section 402a of the lower lift interface assembly 402 and convey outgoing containers 2 off from the lifting platform 404 on to the second interface section 402b of the lower lift interface assembly 402.

It will be understood that the above description of is given by way of example only and that various modifications may be made by those skilled in the art. Although various embodiments have been described above with a certain degree of particularity, or with reference to one or more individual embodiments, those skilled in the art could make numerous alterations to the disclosed embodiments without departing from the scope of this invention. By way of example, it will be appreciated that the features described hereinabove may all be used together in a single system. In other embodiments of the invention, some of the features may be omitted. The features may be used in any compatible arrangement.

By way of further example, in the arrangements illustrated in the Figures the conveyors and each section of each conveyor is illustrated as a roller conveyor. However, each conveyor and/or each section of conveyor could comprise any of a roller conveyor device, a chain conveyor device, a slat conveyor device etc.

What is claimed is:

1. A storage and retrieval system comprising:
a grid;
a plurality of containers located in stacks beneath the grid; and
a container lift disposed beneath the grid, the container lift comprising a lifting platform and a lift mechanism arranged to move the lifting platform vertically, the lifting platform comprising a plurality of lifting positions that are each arranged to receive a container;
a lower lift interface assembly arranged to provide containers to and receive containers from the lifting platform;
an upper lift interface assembly arranged to provide containers to and receive containers from the lifting platform; and
a plurality of load handling devices arranged to move along the grid and configured to move the containers between the stacks and the upper lift interface assembly;
wherein the upper lift interface assembly is arranged to receive containers from a first side of the lifting platform and to provide containers to a second side of the lifting platform.

2. The storage and retrieval system according to claim 1, wherein the upper lift interface assembly comprises a first transfer section and a second transfer section, the first transfer section and the second transfer section being on opposite sides of the lifting platform.

3. The storage and retrieval system according to claim 2, wherein the first transfer section of the upper lift interface assembly defines inward transfer positions at which containers are transferred from the upper lift interface assembly to the load handling devices and the second transfer section of the upper lift interface assembly defines outward transfer positions at which containers are transferred from the load handling devices to the upper lift interface assembly.

4. The storage and retrieval system according to claim 1, wherein the storage and retrieval system is arranged to move the containers longitudinally between the lifting platform and the lower lift interface assembly.

5. The storage and retrieval system according to claim 1, wherein the storage and retrieval system is arranged to move the containers laterally between the lifting platform and the lower lift interface assembly.

6. The storage and retrieval system according to claim 5, wherein the lower lift interface assembly is arranged to provide containers to and receive containers from one of the first side of the lifting platform and the second side of the lifting platform.

7. The storage and retrieval system according to claim 6, wherein the lower lift interface assembly is arranged to provide containers to the first side of the lifting platform and to receive containers from the second side of the lifting platform.

8. The storage and retrieval system according to claim 1, wherein the lifting platform comprises a first platform section and a second platform section, with the first platform section and the second platform section each being configured to receive multiple containers.

9. The storage and retrieval system according to claim 8, wherein the lower lift interface assembly is arranged to provide containers to the first platform section of the lifting platform and receive containers from the second platform section of the lifting platform, and the upper lift interface assembly is then arranged to receive containers from the first platform section of the lifting platform and provide containers to the second platform section of the lifting platform.

10. The storage and retrieval system according to claim 1, wherein the lifting platform comprises a single platform section, the single platform section being configured to receive multiple containers.

11. The storage and retrieval system according to claim 10, wherein the lower lift interface assembly is arranged to provide containers to and receive containers from the single platform section of the lifting platform, and the upper lift interface assembly is then arranged to receive containers from and provide containers to the single platform section of the lifting platform.

12. The storage and retrieval system according to claim 1, wherein the lower lift interface assembly comprises a first interface section and a second interface section, the first interface section being arranged to provide containers to the lifting platform and the second interface section being arranged to receive containers from the lifting platform.

13. The storage and retrieval system according to any of claim 1, wherein the lower lift interface assembly comprises a single interface section, the single interface section being arranged to provide containers to and receive containers from the lifting platform.

14. The storage and retrieval system according to claim 1, wherein lifting platform comprises a first level and a second level, the first level being vertically separated from the second level.

15. The storage and retrieval system according to claim 1, comprises a conveyor system arranged to convey containers into and out from beneath the grid via the lifting platform.

16. A method of operating a storage and retrieval system comprising a grid, a plurality of containers located in stacks beneath the grid, a container lift disposed beneath the grid, the container lift comprising a lifting platform and a lift mechanism arranged to move the lifting platform vertically, the lifting platform comprising a plurality of lifting positions that are each arranged to receive a container, and a plurality of load handling devices arranged to move along the grid and configured to move the containers, the method comprising:
using a lower lift interface assembly to provide containers to and receive containers from the lifting platform;
moving the lifting platform from the lower lift interface assembly to an upper lift interface assembly;
using the upper lift interface assembly to receive containers from a first side of the lifting platform and to provide containers to a second side of the lifting platform; and
using the load handling devices to transfer containers between the stacks and the upper lift interface assembly.
